(19) United States
(12) Patent Application Publication
(10) Pub. No.: US 2004/0071109 A1
(43) Pub. Date: Apr. 15, 2004

(54) Wireless device and network with improved functional architecture

(75) Inventors: Sudhindra P. Herle, Plano, TX (US); Ronald J. Webb, Plano, TX (US)

Correspondence Address: DOCKET CLERK, P.O. DRAWER 800889, DALLAS, TX, 75380, US

(73) Assignee: SAMSUNG ELECTRONICS Co, LTD., Suwon-City (KR)

(21) Appl. No.: 10/441,852

(22) Filed: May 20, 2003

Related U.S. Application Data
(60) Provisional application No. 60/418,013, filed on Oct. 11, 2002.
(60) Provisional application No. 60/417,861, filed on Oct. 11, 2002.

(51) Int. Cl. H04Q 7/00

(52) U.S. Cl. 370/328; 370/338; 370/469

(57) ABSTRACT

A telecommunications device and network that provides TCP/IP communications over the entire data path, thereby simplifying the software call stack needed for a wireless device or to communicate with the network. The device eliminates the upper layers (non-access-stratum) of the handset call stack. It reduces the role of the radio layer to just providing link layer services. Furthermore, the handset call stack communicates with session control and billing & authorization servers over a public network such as the internet. Further, the wireless devices, as well as base stations and other components, communicate with session servers and billing & authorization servers over a public network, such as the Internet, eliminating any need for dedicated private-network connection between these components.

### CROSS-REFERENCE TO OTHER APPLICATION

This application claims priority from U.S. Provisional Patent Application No. 60/418,013, for “4G Handset,” filed Oct. 11, 2002, and U.S. Provisional Patent Application No. 60/417,861, for “4G Network,” filed Oct. 11, 2002, which are both hereby incorporated by reference.

### TECHNICAL FIELD OF THE INVENTION

The present invention relates to improved wireless mobile devices and networks.

### BACKGROUND OF THE INVENTION

Current 3G standards are big and not interoperable across different technologies (CDMA, WCDMA, GPRS/EDGE). Further, the inherent complexity of the standards increases the effort required to implement a cost effective 3G handset.

Call stack for one technology can occupy a significant portion of a phone's resources (as much as 60%). Multi-mode handsets are becoming increasingly common and require more than one call stack on the same handset. Thus, the total software size in multi-mode handsets becomes large. This directly relates to an increase in the manufacturing cost of the handset.

Current 3G technology maintains a separation, however artificial, between voice & data paths. This separation introduces extra layers in the flow of packetized data. This leads to data rates that are much less than what is theoretically possible and ultimately translates to poor user experience.

Finally, maintaining common software applications for use in multi-mode handsets is troublesome.

FIG. 1 illustrates the various software layers of a typical 3G WCDMA handset. In this figure, each block indicates a functional unit and software layer required to support various functionality according to current Universal Mobile Telecommunication System (UMTS) standards. The labeled blocks represent various known protocols as follows:

| | |
|---|---|
| CC | Call Control |
| GMM | GPRS Mobility Management |
| MAC | Medium Access Control |
| MM | Mobility Management |
| RLC | Radio Link Control |
| RRC | Radio Resource Control |
| SM | Session Management |
| SMS | Short Message Service |

It can be seen that specific service protocols account for 60% of the software-layer overhead in a typical 3G mobile device. The complexity of 3G and the cost of deploying it will cause the operators to price the services up to 10× the cost of competing alternative technologies. It will make the handsets more expensive to manufacture and thus, more expensive to buy.

It would therefore be desirable to provide a system, method, and wireless telecommunications network in which the software-layer overhead of the wireless device and the need for private-network connections are reduced.

### SUMMARY OF THE INVENTION

The preferred embodiment includes a telecommunications network that provides TCP/IP communications over the entire data path, thereby simplifying the software call stack needed for a wireless device or to communicate with the network. The preferred embodiment eliminates the upper layers (non-access-stratum) of the handset call stack. It reduces the role of the radio layer to just providing link layer services. Furthermore, the handset call stack communicates with session control and billing & authorization servers over a public network such as the internet. Further, the wireless devices, as well as base stations and other components, communicate with session servers and billing & authorization servers over a public network, such as the Internet, eliminating any need for dedicated private-network connection between these components. One embodiment provides a mobile terminal comprising a first software layer for wireless communications link control; and a second software layer for session control and communications, wherein the second software layer communicates with a session control system over a public network. Another embodiment provides a wireless communications network comprising a plurality of base stations configured to communicate with at least one mobile terminal; a gateway configured to deliver communications from the mobile terminal to the public switched telephone network; a session control system configured to control communications with the mobile terminal over a public network; and a call accounting system configured to control communications with the mobile terminal over a public network. Still another embodiment provides a method for enabling wireless communications, comprising receiving, in a base station, an internet-protocol communications request from a wireless device; transmitting an authorization request corresponding to the internet-protocol communications request, over a public network, to a wireless carrier authorization server; receiving a service authorization corresponding to the communications request from the wireless carrier authorization server; and enabling voice-over-internet-protocol communications between the wireless device and the public network.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates the various software layers of a typical 3G WCDMA handset;

FIG. 2 illustrates an improved wireless device with a simplified call stack architecture in accordance with the preferred embodiment;

FIG. 3 depicts basic components of a known telecommunications system;

FIG. 4 illustrates a known UMTS/W-CDMA network;

FIG. 5 illustrates the software call-stack architecture of a typical UMTS/W-CDMA mobile terminal;

FIG. 6 illustrates an improved network architecture in accordance with a preferred embodiment; and

FIG. 7 shows a wireless network configuration with BTS connected directly to the internet, in accordance with a preferred embodiment of the present invention.

### DETAILED DESCRIPTION OF THE INVENTION

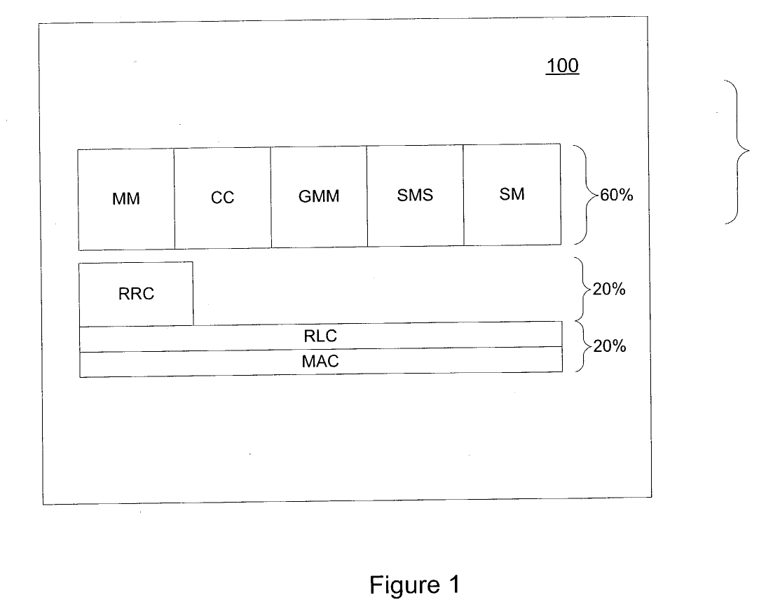

FIGS. 1 through 7, discussed herein, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

Definitions—For the convenience of the reader, following are short definitions of the usual meanings of some of the technical terms and acronyms which are used in the present application, which are familiar to those of skill in the art. Of course, those of ordinary skill will recognize whether the context requires a different meaning or a specific usage, particularly where an acronym can be used in multiple ways. Additional definitions can be found in the standard technical dictionaries and journals:

| | |
|---|---|
| 3G | “3rd generation”, generally applied to wideband mobile |
| | services and applications |
| BCC | Broadcast Call Control. |
| BSS | Base Station System |
| BTS | Base Transceiver Station |
| CC | Call Control |
| CDMA | Code Division Multiple Access |
| CDMA2000 | Common name for IMT-2000 CDMA Multi-Carrier. |
| DSL | Digital Subscriber Line |
| EDGE | Enhanced Data rate for GSM Evolution |
| GCC | Group Call Control |
| GGSN | Gateway GPRS Support Nodes |
| GMM | GPRS Mobility Management |
| GPRS | Generalized Packet Radio Service/System |
| GSM | Global Standard/System for Mobile telecommunications |
| GSM | GPRS Session Management |
| GTP | GPRS Tunneling Protocol |
| ICMP | Internet Control Message Protocol |
| IGMP | Internet Group Message Protocol |
| IP | Internet Protocol |
| IWF | Interworking Function |
| MAC | Medium Access Control |
| MIDP | Mobile Information Device Profile |
| MM | Mobility Management |
| Mobile IP | An Internet Engineering Task Force (IETF) standard |
| | communications protocol that is designed to allow mobile |
| | device users to move from one network to another while |
| | maintaining their permanent IP address. |
| MSC | Mobile Switching Center |
| MSS | Mobile Satellite Services |
| MTP-3B | Message Transfer Part Level 3B |
| PLMN | Public Land Mobile Network |
| PSTN | Public Switched Telephone Network |
| RANAP | Radio Access Network Application Protocol |
| RLC | Radio Link Control |
| ROHC | Robust Header Compression |
| RRC | Radio Resource Control |
| RTP | Realtime Transport Protocol |
| SCCP | Signaling Connection Control Part |
| SGSN | Serving GPRS Support Node |
| SIP | SMDS Interface Protocol |
| SIP | Session Initiation Protocol |
| SM | Session Management |
| SMDS | Switched Multimegabit Data Service |
| SMS | Short Message Service |
| SNDCP | Sub-Network Dependant Convergence Protocol |
| TCP | Transmission Control Protocol |
| UDP | User Datagram Protocol |
| UMTS | Universal Mobile Telecommunications System |
| W-CDMA | Wideband-CDMA |
| WLAN | Wireless Local Area Network |

According to the preferred embodiment, TCP/IP and its family of protocols are used universally for all connectivity within the network and outside, until translated at a PSTN gateway.

Traditional call control features are realized via SIP and extensions to it. The payload for voice traffic is handled by RTP.

ROHC (Robust Header Compression) is employed to make the radio layer efficient for the transport of signaling and voice traffic.

Mobility management is split into two levels—local radio layer mobility and IP level mobility (MobileIP). Mobile IP is used only during an active data transfer session (voice or data).

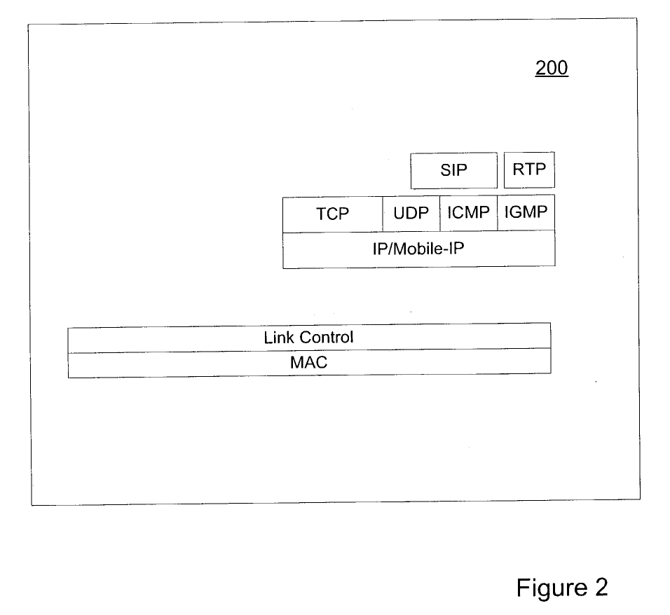

FIG. 2 illustrates an improved wireless device with a simplified call stack architecture 200 in accordance with the preferred embodiment. This figure illustrates the various software layers of an improved wireless device/handset in accordance with the preferred embodiment. In this figure, each block indicates a functional unit and software layer required to support various functionality according to a disclosed embodiment. The labeled blocks represent various protocols as follows:

| | |
|---|---|
| ICMP | Internet Control Message Protocol |
| IGMP | Internet Group Message Protocol |
| IP | Internet Protocol |
| SIP | Session Initiation Protocol |
| RTP | Realtime Transport Protocol |
| TCP | Transmission Control Protocol |
| UDP | User Datagram Protocol |
| MAC | Medium Access Control |

As shown in this FIG. 2, simplifying the radio layers and eliminating the upper layer non-access stratum of the call stack significantly reduces code size and memory requirements in a wireless device.

Further, the simplified radio layers of the preferred embodiment makes the core network “radio agnostic,” that is, immune to changes in the radio access technology. Each of the protocols used, and the hardware and software required to support them, are mature, well understood by those of skill in the art, and widely available.

Using the software architecture shown in FIG. 2, the network becomes “flat” and infrastructure costs decrease. The simplified packet-based core network is free of extraneous layers and thus, faster speeds become possible. It will be possible for the network to offer truly seamless global roaming.

Using SIP provides the consumer with a single global identity the consumer can use on the phone, at home or a PC. The link layer services provided by the radio layer can be implemented by re-using technology from current 3G standards (e.g., CDMA2000, GPRS/EDGE, WCDMA). It can also be realized using emerging technology such as Flarion OFDM, MeshNetworks, and others. The preferred embodiment is intended to be radio agnostic and work with any link-access technology.

The novel features of the preferred embodiments include, but are not limited to:

1) A network architecture that simplifies an overly complex architecture in both wireless devices and the network.

2) A network architecture that unifies divergent cellular technologies (GSM, UMTS, IS-2000, 802.11, etc) into a common method for radio (network) access.

3) A network architecture that makes the core network “radio agnostic”—and thus, universal.

4) A network architecture that leverages the low cost of off-the-shelf commodity hardware to greatly reduce the infrastructure cost, enabling current 3G to be profitable.

5) the device of the preferred embodiment provides for a much greater speeds and thus user experience.

Some important elements of the improved wireless device are:

1) The bulk of the “call stack” is gone. The SIP layer has subsumed its functionality.

2) The radio layers are small and efficient. They no longer perform the complex things as the WCDMA radio layer. Their function is limited to establishing a radio link with a given QoS (bitrate, iso-chronous etc.).

3) The radio layers perform limited mobility management.

4) Information about the radio layer is not propagated to upper layers; thus, the upper layers are completely radio agnostic.

5) Mobile IP handles mobility when in a conversation.

There are fundamental problems in the wireless network today that complicate the future of 3G. Some of these problems are economic and some technical. The primary reason for deploying 3G technology is to provide high-speed data and data services. However, the definition of “high-speed” and the expectation of what it should cost are being determined in other markets.

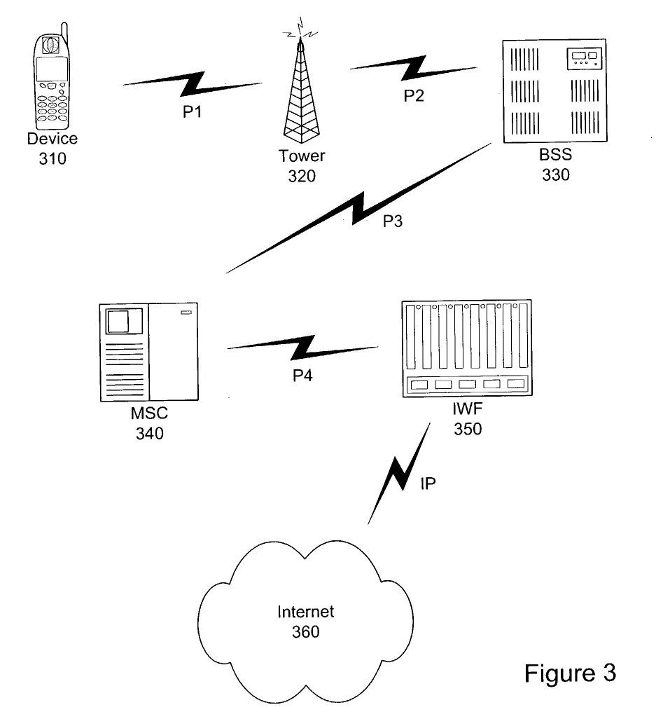

The current 3G network is very centralized and is overly complex. Although meant to carry voice & data simultaneously, it still retains a circuit switched, hierarchical architecture. For example, when data-service was added to CDMA, it became necessary to invent a new box called the IWF and a separate set of protocols for controlling the data stack (IS-707). In fact, the links between different network elements all run different and proprietary protocols. Adding support for open protocols and services require proprietary changes to several boxes in the network. As shown in FIG. 3, each of the boxes in the network is customized for each operator and they come with a significant price penalty.

In FIG. 3, basic components of a known telecommunications system, including device 310, tower 320, BSS 330, MSC 340, IWF 350, and the internet 360, communicate with each other in a known fashion. Currently, each connection (other than to internet 360) is typically made by a proprietary communications protocol, indicated by P1, P2, P3, and P4.

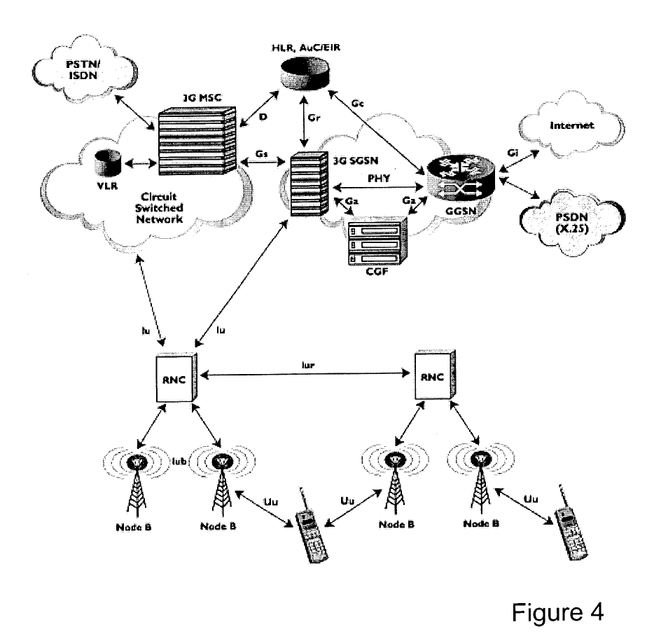

FIG. 4 illustrates a known UMTS/W-CDMA network. A call setup (voice or data) from the mobile terminal needs intervention from almost every network element. IP packets from a mobile must go through the SGSN and GGSN. These and other boxes in the network add little value. They are generally a source of unwanted complexity and bottleneck.

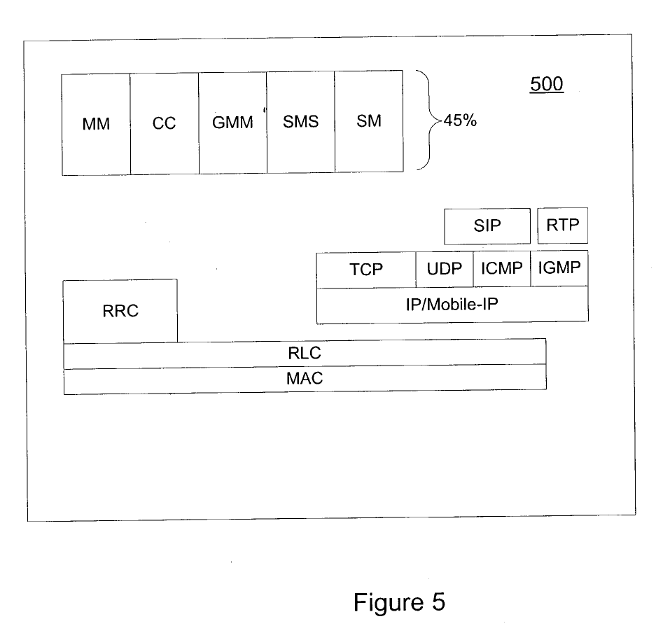

These 3G functions are very complex and difficult to implement. FIG. 5 illustrates the software call-stack architecture of a typical UMTS/W-CDMA mobile terminal.

Note that this mobile terminal 500 combines the voice and data software-layer components of both FIG. 1 and FIG. 2. The bulk of the complexity of this typical mobile terminal comes from trying to keep voice & data distinct. The 3GPP standards demand highly complex and verbose data encoding formats. Data and voice services use different mechanisms for control and these control-channels are terminated on separate boxes (which are not off-the shelf hardware). Note that the non-data layers account for 45% of the software overhead.

In the case of CDMA2000 3×, the technology is even more complicated—simultaneously demodulating and processing three different physical channels (3×1.25 MHz channels) and synchronizing data content. This level of complexity will cause the technology to be practically obsolete even before it is developed.

For CDMA2000 1×EV-DV, the base station uses multiple Walsh codes simultaneously for the packet data channel. This means, the mobile terminal has to de-spread up-to 26 Walsh codes simultaneously in order to receive packet data. This kind of complexity makes implementation difficult in the network and terminal.

The big promise of 3G technologies was “high speed data”. However, to date, the best data rate that has been possible in lab conditions is: 128 kbps. During the 2002 GSM World Congress in Cannes (France), several leading vendors tried to demonstrate UMTS high-speed data. Most vendors were able to achieve 64 kbps while a single vendor was able to show 128 kbps.

The disclosed embodiments for improved wireless devices and networks reduce or eliminate these problems.

The Improved Network

The main obstacle to ubiquitous data access is at the edge of the network (the “access network”). The improved architecture of the present invention enables 3G features and capabilities to be profitable. It will enable high-speed data and always-on data for mobile terminals. And, it will protect investments in legacy services such as voice. The first step in improving the 3G network is to simplify the core network.

Description of Network Elements

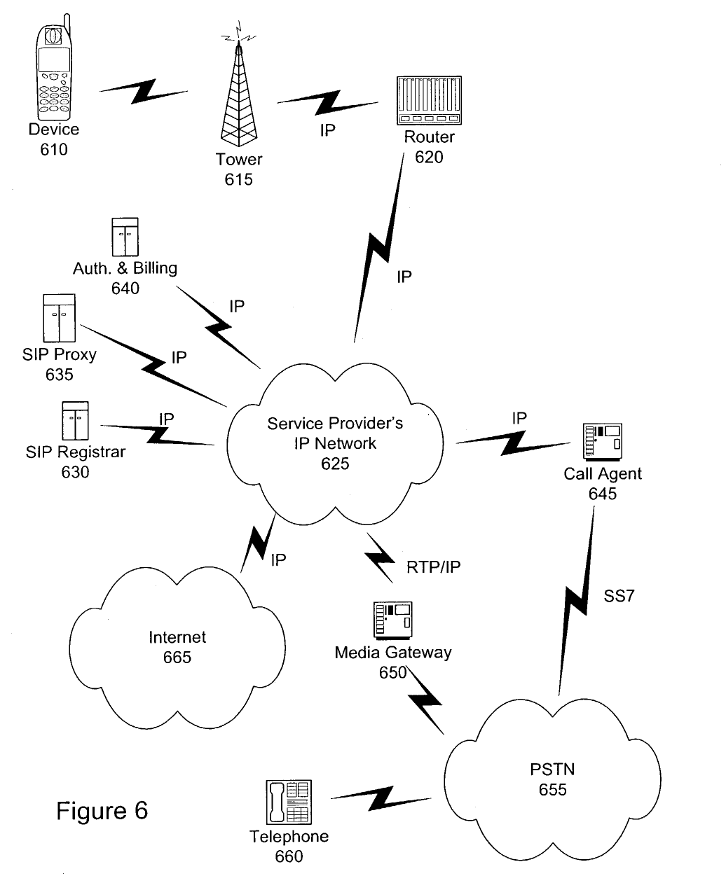

FIG. 6 illustrates an improved network architecture in accordance with a preferred embodiment. In this FIGURE, wireless device 610, which may be a mobile phone, PDA, or any other wireless device, connects with tower 615 using any data-capable wireless protocol. Tower 615 communicates with router 620, which may be located at the tower itself, within a base station, or other suitable location, using an IP connection. Router 620 uses an IP protocol to communicate with the service provider's IP network 625. Note that, in the disclosed network embodiments, where two components communicate, it may be over wire, fiber optic cable, or other suitable medium, and there may be intervening known components, such as a router, firewall, or gateway, to facilitate and secure the communication.

An SIP proxy 630, SIP registrar 635, and authorization and billing system 640 also connect to the service provider's network 625, for call processing functions. Further, calls can be routed to telephone 660 on PSTN 655 through media gateway 650, using call agent 645 for SS7 call processing.

Finally, the service operator's IP network 625 connects to the Internet 665. Note that while single ones of various components, such as routers, towers, and devices, are shown for the sake of clarity, in operation, many of each of these and other devices will be connected to the preferred network.

According to this preferred network, TCP/IP is the universal protocol used between the terminals and all network elements. The radio layer is reduced and simplified to provide the last-mile link layer connectivity; i.e., it becomes a point of “attachment” for the mobile device. The core-network is an IP network inter-connected via routers.

All call control mechanisms are provided by SIP. Payload for voice calls is handled by RTP. The operator's internal network is completely IP based—from the radio tower all the way to the Internet (or PSTN Gateway). A PSTN Gateway provides connections to legacy PSTN (PLMN) networks—which is essentially an off-the-shelf server running a protocol converter. Mobility is handled first by the radio layers (Medium Access) and then by Mobile-IP. No mobility related operation is propagated to the call-control layer.

In FIG. 6 above, the IP connection between the radio-tower and the nearest router doesn't have to be a dedicated connection. It is quite possible for the radio-tower to be directly connected to the Internet, using a typical router, gateway, or other standard hardware. In such a scenario, deployment of the network is greatly simplified. It also has the additional advantage of distributing the network load from the mobile terminals, as traffic from the terminals is not forced to go through the operator's core-network (routers) in order to reach the Internet.

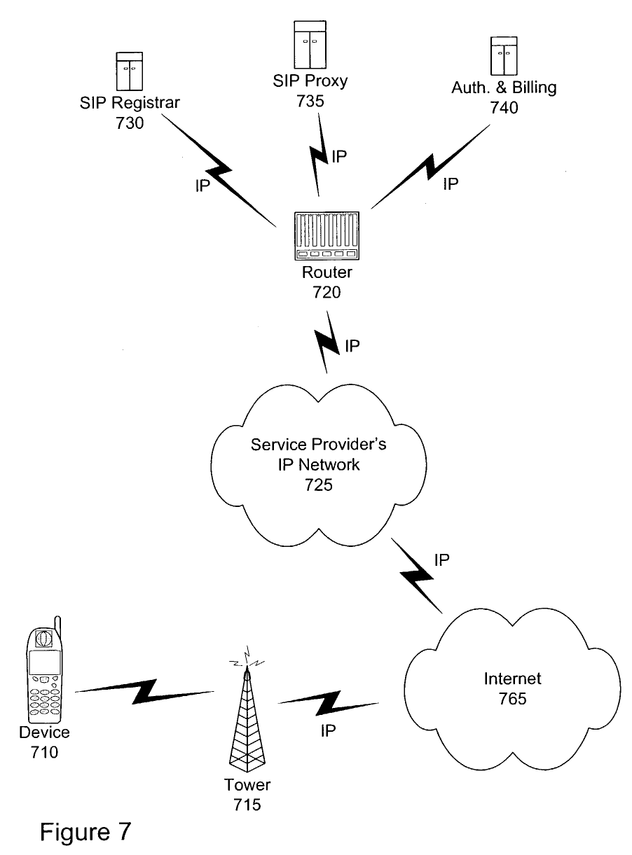

FIG. 7 shows a wireless network configuration with BTS connected directly to the internet, in accordance with a preferred embodiment of the present invention. Here, device 710 connects to tower 715, which is connected, via IP connection, directly to the Internet 765. Also connected to the Internet is the service provider's IP network 725.

An SIP proxy 730, SIP registrar 735, and authorization and billing system 740 also connect to the service provider's network 725, for call processing functions, via router 720. Note that tower 715 will connect and communicate with SIP registrar 735, SIP proxy 730, and authorization and billing system 740 over the public network, and thereby through the service provider's network 725, as will mobile devices connecting through tower 715. This provides an important advantage in that the service provider's network does not have to be extended to each tower or connection.

Radio Tower

In the preferred network, the radio tower is an entity providing a point of attachment for wireless devices. The radio tower is connected to the rest of the network by a pure IP link. Beyond the radio tower, most network entities do not care, nor do they have any knowledge, that the IP packets are from a wireless device.

Routers

Routers play a central role in the new network. They provide the following minimum services in addition to their traditional role of IP routing:

IP Address assignment

Mobile-IP Home Agent and Foreign Agent

Authentication request forwarding

One can simplify the notion of “mobility” by recognizing that:

(a) True mobility is only needed when the mobile-terminal is in motion during active traffic session (voice or data). In this case, Mobile IP can handle the change-of-attachment point procedures; and

(b) When the mobile is not in an active traffic session (dormant/idle), then the point of attachment can be re-established (or re-negotiated) with the network.

Core Network

The core network is simplified to being just a collection of IP routers providing connectivity to various IP based services in the network.

Authentication & Billing Server

The authentication and billing server is responsible for distinguishing authorized vs. unauthorized mobiles. In a SIP based environment, this also maintains a mapping between a cellular subscriber telephone number and a Globally unique SIP identity. The billing component collects IP packet metrics from various nodes in the network on a per IP address (subscriber) basis.

SIP Proxy & Registrar

The SIP Proxy and Registrar play a central role in the preferred network. The SIP proxy provides the means for a wireless device to locate other devices within its network; or, forward requests to the Call-Agent that handles connections to the PSTN.

The role of the SIP registrar is to provide a mapping between the well-known SIP-identity of each wireless-user and the latest IP address. This information is required for mobile-terminated calls.

Call Agent and Media Gateway

The Call Agent is required to translate SIP signaling to PSTN signaling (SS7 or something similar). The Media Gateway is responsible for converting media formats between PSTN and other RTP based codec format.

Advantages of the Disclosed Network Architecture:

1) The radio layers are terminated at the BTS. Thus, the modulation specific software & hardware is limited to the wireless device-BTS air interface. Beyond the BTS, nobody knows or cares whether the user has a GSM or CDMA phone. This means that the same core network will work with any phone.

2) The network elements are off-the-shelf, hardware—thus lowering deployment and operating costs enormously.

3) The network provides true global roaming—blurring the distinction between a mobile and a stationary device (PC). The use of SIP allows a user to truly have a single identity no matter where he may be—home, office or on the road.

4) Offers a way to preserve legacy investments and provide a safe migration path to the next generation network.

5) CDMA & GSM can truly interwork—thus making UMTS harmonization unnecessary.

Those skilled in the art will recognize that, for simplicity and clarity, the full structure and operation of all devices suitable for use with the present invention is not being depicted or described herein. Instead, only so much of a wireless device as is unique to the present invention or necessary for an understanding of the present invention is depicted and described. The remainder of the construction and operation of the disclosed wireless devices and networks can conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A mobile terminal comprising:
a first software layer for wireless communications link control; and
a second software layer for session control and communications,
wherein the second software layer communicates with a session control system over a public network.

2. The mobile terminal of claim 1, wherein the first software layer includes a link control component and a medium access control component.

3. The mobile terminal of claim 1, wherein the second software layer comprises software components selected from the group consisting of an Internet Control Message Protocol component, an Internet Group Message Protocol component, a Internet Protocol component, a Session Initiation Protocol component, a Realtime Transport Protocol component, a Transmission Control Protocol component, a User Datagram Protocol component, and a Medium Access Control component.

4. The mobile terminal of claim 1, wherein the session control system is a session initiation protocol proxy.

5. The mobile terminal of claim 1, wherein the session control system is a session initiation protocol registrar.

6. The mobile terminal of claim 1, wherein the public network is the internet.

7. The mobile terminal of claim 1, wherein the first software layer communicates with an authorization system over the public network.

8. The mobile terminal of claim 1, wherein the first software layer controls local radio layer mobility and the second software layer controls internet-protocol mobility, and wherein the second software layer is only used during an active data or voice transfer session.

9. The mobile terminal of claim 1, wherein no third software layer is present.

10. A wireless communications network comprising;
a plurality of base stations configured to communicate with at least one mobile terminal;
a gateway configured to deliver communications from the mobile terminal to the public switched telephone network;
a session control system configured to control communications with the mobile terminal over a public network; and
a call accounting system configured to control communications with the mobile terminal over a public network.

11. The wireless communications network of claim 10, wherein the public network is the Internet.

12. The wireless communications network of claim 10, wherein all communications are internet protocol communications.

13. The wireless communications network of claim 10, wherein the session control system is a session initiation protocol proxy.

14. The wireless communications network of claim 10, wherein the session control system is a session initiation protocol registrar.

15. A method for enabling wireless communications, comprising;
receiving, in a base station, an internet-protocol communications request from a wireless device;
transmitting an authorization request corresponding to the internet-protocol communications request, over a public network, to a wireless carrier authorization server;
receiving a service authorization corresponding to the communications request from the wireless carrier authorization server; and
enabling voice-over-internet-protocol communications between the wireless device and the public network.

16. The method of claim 15, further comprising transmitting the voice-over-internet-protocol communications to a public service telephone network gateway.

17. The method of claim 15, further comprising transmitting a message corresponding to the communications request to a session initiation protocol proxy.

18. The method of claim 15, further comprising transmitting a message corresponding to the communications request to a session initiation protocol registrar.

19. The method of claim 15, wherein the communications request includes a wireless device identifier.

20. The method of claim 15, wherein the public network is the internet.
